(19) United States
(12) Patent Application Publication
(10) Pub. No.: US 2015/0142669 A1
(43) Pub. Date: May 21, 2015

(54) VIRTUAL PAYMENT CHIPCARD SERVICE

(71) Applicant: Mads Landrok, San Jose, CA (US)

(72) Inventor: Mads Landrok, San Jose, CA (US)

(21) Appl. No.: 14/082,126

(22) Filed: Nov. 16, 2013

(51) Int. Cl. G06Q 20/40; G06Q 20/34

(52) U.S. Cl. CPC G06Q 20/40; G06Q 20/34
USPC 705/71; 705/44

(57) ABSTRACT

A virtual payment chipcard service depends on a secure, back-end network server configured to maintain chipcard authorization data and computational services as virtual assets in the Cloud. These are behind tamper resistant boundaries, and, on user transaction request, arranged to electronically sign a transaction on the user's behalf as a proxy to a virtual chip-card payment. Two independent and concurrent user communication channels connected to the network server are configured to receive user transaction requests on one user communication channel, and to enable the network server to make confirmations with said user on the other user communication channel.

### CO-PENDING APPLICATION

This application is a Divisional of U.S. patent application Ser. No. 13/404,023, filed Feb. 24, 2012, and titled CLOUD PROXY SECURED MOBILE PAYMENTS.

### BACKGROUND OF THE INVENTION

1. Field of the Invention

The present invention generally relates to mobile payments, and in particular to secure, back-end network servers configured to maintain chipcard authorization data and computational services as virtual assets in the Cloud to act as proxies.

2. Description of the Prior Art

Traditional magnetic stripe based credit and debit cards are now widely used by consumers to make point-of-sale (POS) purchases and online (card-not-present) purchases. Both of these reveal the account number, user's name, and expiry dates to the Merchant and anyone else handed the card, listening in, or with access to the purchase records. In contrast, online PayPal purchases keep most of the user account information away from the merchants, and rely on passwords and email addresses to key up the user's account. PayPal enters the transaction as a sort of proxy or intermediary that both parties trust.

Conventional smart cards are credit card sized devices with embedded tamper-resistant computer chips. When used for security, these chips can store and protect user authentication and transaction credentials. At least to some degree. But, smart card authentication requires a special card reader. Strong, two-factor authentication is made possible that relies on a PIN or password only the user knows.

Europay, MasterCard, and Visa formed the EMV Company, EMVCo LLC, and now publish the so-called “Integrated Circuit Card Specifications for Payment Systems”. These specifications are related to ISO-7816 and create a common technical basis for card and system implementation of a stored value system. Many new secure ID system implementations are using both biometrics and smart cards to improve the security and privacy of modern ID systems.

VISA's dynamic passcode authentication (DPA) and Mastercard's chip authentication protocol (CAP), enable EMV IC smart cards to secure Internet transactions where the card cannot be read directly by the merchant terminals. The what-you-have security factor in the transaction is therefore not directly available. In the DPA and CAP schemes, the smart card is instead inserted by the cardholder into a private, pocket-sized, dynamic passcode generator and their PIN is entered. If the PIN is correct, a software application on the smart card computes a one-time, time-sensitive passcode, unique to that transaction. Such passcode is read out aloud or entered into a form by the cardholder to complete the transaction. The use of a one-time passcode proves that the actual smart card itself was involved in transaction and that a correct PIN was entered, therefore qualifying as strong, two-factor authentication.

A security authentication module (SAM) card is a smart card similar in appearance to a SIM card. SAM cards typically store cryptographic keys inside point of sale (POS) terminals. Advanced Card Systems, Ltd., (Hong Kong), for example, markets their ACOS6 SAM card as a secure store for cryptographic keys which are used to compute cryptograms in smart payment cards. The terminals do not need to know the master key of an application, and the keys never leave the SAM. Mutual authentication is used to guarantee the authenticity of the terminal and the client card. Secure messaging is used to ensure the data transmission between the card and terminal or server is not vulnerable to eavesdropping, replay attack, or unauthorized modifications. Purse MAC Computation is used to authenticate and ensure data integrity of data and commands that are transferred. Key diversification enables diversified entry of keys without exposing the master key. Secure key injection is used to ensure the key injection from SAM to client cards. Proprietary information stored in each SAM is used to verify the validity of the card.

Unfortunately, the distribution of new SAM-enabled SIM cards to smartphone subscribers is logistically complex, and the end users need to be trained in their use. Mobile payment users must either install a SAM in each of their devices, or buy devices that already have a SAM or a built-in secure element (SE). If implemented responsibly, the results will be secure. But this approach has significant business hurdles to being practical. Mobile network providers (MNPs) control the SAMs and the SEs, issuing banks typically control the payment schemes, and the two have no history of effective cooperation. So be able to deploy a system that works is not assured.

The recently announced ISIS mobile payment system includes an app to store credit card information on near field communication (NFC) enabled smartphones, ISIS enabled point of sale (POS) terminals, and even ISIS price tags. This electronic wallet is supposed to help a user avoid carrying actual and numerous cards in a conventional wallet. So, instead of swiping a traditional credit card and signing or entering PIN to approve the payment, users tap their mobile devices on ISIS-enabled POS terminals. The tap is sensed by accelerometers wired to trigger and identify the parties in an electronic payment to be credited from the user account to the merchant. ISIS cards can be used to electronically wallet a broad range of accounts: credit cards, debit cards, reward cards, discount coupons, payment coupons, tickets, transit passes, etc.

Mobile handheld devices like smart smartphones, tablets, ultrabooks, and other personal trusted devices (PTD's) have become ubiquitous, all-in-one assistants that provide us all with phone, email, encyclopedia, diary, calendar, and many more valuable, instant services. Now these PTD's are also fast becoming our wallets and keys.

In the 1990's, Europay, MasterCard, and Visa (EMV) decided in Europe to switch from magstripe to “smart” chipcard and encryption technology. The changeover is still not complete twenty years later because the magstripe technology was and is so well entrenched, especially in the United States. The EMV chipcard technology enable each payment cards to generate corresponding digital signatures that can be used to secure transactions. Although inherently more secure than the magnetic stripe cards, smart cards suffer from many of the same issues. They must be issued, distributed, carried, and then used only in POS terminals and other specially designated hardware devices. For example, MasterCard Chip Authentication Program (CAP) token readers.

In order to deal will these shortcomings, Cryptomathic (UK) developed a virtual chipcard for generating digital signatures, e.g., for signing documents with legal value at the exclusive instruction of the user. The object was to have electronic signatures available on a remote service, never routinely reveal those signatures outside a secure area in the Cloud. Such signatures are based on strong authentication of the user and/or their security token.

Client-side identification and authentication cards have improved internet banking application security. But if an account holder's computer is infected with malware, the keyboard and display screen communication between the user and the application can be overridden. Man-in-the-browser malware can modify transactions and go completely unnoticed by the user.

In another variation on security, an online banking service in Belgium, Dexia Direct Net, relies on a standalone, unconnected smart card readers equipped with a numeric keypad and a screen called Digipass. In order to complete a transaction, each user is asked to sign the transaction with their Digipass by inserting their bank card and entering their PIN code.

Deutsche Bank has an online banking service that requires the use of a Codecard associated to the user, and that is identified by a serial number. An array of codes is displayed on its surface. Users must login with a password and the Codecard to identify themselves to a website. The passwords are verified by the website. When a user confirms a transaction using the service, the website asks the user for one of the forty possible codes displayed on the Codecard. Unfortunately, all such transactions are subject to man-in-the-browser attacks.

The general failings in all the proposed schemes now circulating is that they cannot be employed immediately with existing mobile devices typically in the hands of users worldwide. Just about all of these require some hardware component to be bought, installed, or included for the mobile payment scheme to function. Several large technology and banking interests would like to capture the whole mobile payments market, but the solutions they offer usually just park their users in small market segments.

What is needed is a mobile payments system that can bestow the benefits of chip card user authentication on consumers equipped with only common mobile devices that they use routinely in their daily lives.

### SUMMARY OF THE INVENTION

Briefly, a virtual payment chipcard service embodiment of the present invention depends on a secure, back-end network server configured to maintain chipcard authorization data and computational services as virtual assets in the Cloud. These are behind tamper resistant boundaries, and, on user transaction request, arranged to electronically sign a transaction on the user's behalf as a proxy to a virtual chip-card payment. Two independent and concurrent user communication channels connected to the network server are configured to receive user transaction requests on one user communication channel, and to enable the network server to make confirmations with said user on the other user communication channel.

These and other objects and advantages of the present invention will no doubt become obvious to those of ordinary skill in the art after having read the following detailed description of the preferred embodiments that are illustrated in the various drawing figures.

### IN THE DRAWINGS

FIG. 1A is a functional block diagram view of a registration system useful in one part of a virtual chipcard secure payment system embodiment of the present invention;

FIG. 1B is a functional block diagram view of a transaction system useful in a second part of the virtual chipcard secure payment system of FIG. 1A;

FIG. 2 is a functional block diagram view of a virtual chipcard secure payment system that relies on a personalization data service mechanism to provision a payment transaction proxy with virtual EMV-type chipcards on a secure backend server in the Internet Cloud;

FIG. 3 is a flowchart diagram representing a first scenario in which a shopper uses their smart connected computing device to make a purchase at a merchant's POS terminal;

FIG. 4 is a flowchart diagram representing a second scenario in which a shopper uses more than one of their smart connected computing devices to make a purchase remote from a merchant's POS terminal or to engage in a transaction with a peer;

FIG. 5 is a flowchart diagram representing a third scenario in which a shopper has only one of their smart connected computing devices on hand, and uses it to make a purchase remote from a merchant's POS terminal or to engage in a transaction with a peer; and

FIG. 6 is a flowchart diagram representing how requests for transactions are forwarded by user devices to a virtual chip card service, such as can be implemented with a secure server like is shown in FIGS. 1A-1B.

### DETAILED DESCRIPTION OF THE PREFERRED EMBODIMENTS

In general, embodiments of the present invention provide users with secure access to their payment card accounts, identification, and various kinds of restricted control mechanisms for physical and electronic property. The secure applications, secret personalization data, and unique identifiers used in authentication are never actually in the hands of any user. The necessary authorization data and computational services are instead maintained as virtual assets in the Cloud behind tamper resistant boundaries, e.g., as specified by Federal Institute of Processing Standards (FIPS) 140-2 Level 3+, also, Common Criteria Evaluation Assurance Level (CC EAL 4+). These protected applications are used to produce secure computation outputs that are derived from pre-registered personalized security parameters and depend on the inputs currently provided by the professed registered user.

Conventional user devices like cellphones, smartphones, tablets, PC's, and other mobile electronics are inventoried over a network with their unique identifiers on a registration server. These user devices are relied on during secure transaction requests to be able to communicate between secure servers and each user over multiple independent and concurrent communications channels. For example, the mobile telephone networks, email, SMS text, Internet, 4G packet service, etc. Each additional device, and each additional communications channel that can be involved in a secure transaction can be employed to incrementally raise the authentication confidence levels by adding another, independent security factor.

The authentication of a device includes recognizing and/or validating a given user's device by relying on pre-established, identifiers unique to the device that were surveyed during registration. If possible, the individual natures of these unique identifiers are such that they cannot be copied or spoofed, e.g., as in an identification protocol such as a challenge response-based queries to special purpose hardware on a device that has been individually personalized using cryptographic keys.

Some embodiments of the present invention include processors to score user, device, and message authentication confidence levels, and such processors are able to summon additional security factor inputs if the nature of the present transaction is such that the user or the secure application hosting services determine that stronger levels of authentication are appropriate.

Conventional financial transactions typical use a single channel of communication that is one-way from the user's payment card to the point of sale (POS) terminal, and on to the payment server. Smart payment cards, in the hands of the users themselves, will compute a cryptogram and output it for the POS terminal if the user at a minimum has input a correct password. A simple message that the transaction has been approved is usually the only thing returned to the POS terminal. At best, the user will get a paper receipt showing the details of the transaction as the POS terminal best understands it. The payment server may have a different record if the communications channel has been compromised and the user account was assaulted during or after the transaction.

A handshake signaling end-to-end between the user and the payment server allows both ends to understand what the other intends to be the main parameters of the transaction, e.g., the transaction value and merchant involved. Embodiments of the present invention therefore deploy a user transaction proxy server on the Internet Cloud that authenticates the users with two-channel handshakes involving passwords, confirmations, and even cryptographic calculations. Crypto-encoded credentials or keys issued by a bank, for example, are stored in the Internet Cloud in the user transaction proxy server and provided privately to the payment processor after user verification. The actual credentials or keys are generally not exposed to the users or the POS terminals they patronize. Some exposure may be required by particular payment schemes in order to compete a transaction.

Each typical user will have several mobile devices they employ in their daily lives. Each of these can be supported by a variety of communications service providers, e.g., high speed Internet service, telephone, wireless mobile, email, and 4G packet networks, or even fax. Each of these are strongly associated with corresponding IP-addresses, email addresses, SIM cards, electronic serial number (ESN), international mobile equipment indicator (IMEI), subscriber phone numbers, etc. And each can support a message delivered to a single destination.

A typical smartphone can log onto a webpage and receive emails simultaneously, e.g., by using two different communications channels and respective application programs. For purposes of the present invention, it is important that any of the communications channels and devices employed be available for contemporaneous, concurrent, or simultaneous use. The users' venues can change transaction-by-transaction, so the current device environment is important to understand so unavailable channels and devices can be predicted and no effort will be wasted on them. For example, at home or in their office, a user's fax machine could be a viable device using a hardwired fax line for the communications channel. But in a merchant's store, that would not be an option. However, the merchant's POS terminal could be employed as a device and channel between the user and the transaction proxy server.

In general, modern mobile, personal trusted devices can be strongly authenticated using uniquely identifiable functionality embedded within their circuitry. At the same time, non-protected and non-isolated memory space in such devices makes them all too vulnerable to attacks aimed at stealing any cryptographic keys that may be present. It is understandable then a new system and method is needed that does not park cryptographic keys on such devices. Then there would be nothing to steal from the mobile devices.

3-D Secure is an XML-based protocol used as an added layer of security for online credit and debit card transactions. Visa uses it to improve the security of Internet payments and offered it to customers as the Verified by Visa service. XML messages are sent over secure socket layer (SSL) connections with client authentication that uses digital certificates to ensure the authenticity of both peers, the server and the client. Transactions initiate a redirect to a website operated by the card issuing bank to authorize the transaction. Typically a password-based authentication method is used, so purchases on the Internet require using passwords tied to the card. Similar services based on the protocol have also been adopted by MasterCard, e.g., SecureCode, and by Japan Credit Bureau (JCB) International as J/Secure. American Express has SafeKey in the UK and Singapore.

What is needed is first, a way to create a strong binding between users and the peculiar combination of devices they own and the associated authentication services they subscribe to. That combination reduces to one user only who can establish access to the keys in another secure service without having to hold or reveal the keys themselves to authorize payment. Second, a secure backend payment server is triggered to produce the same output as would have been produced by the user had they used a payment chip card. The keys therefore never have to leave the backend server.

In a virtual payment chipcard service for secure payments, a chip-card calculation is emulated on a secure back-end to allow users to pay in the Cloud without the risk of compromising their cryptographic keys. Strong authentication of the user and/or the message to be signed is used in validating the user's intent. Such serves as a means for the user to effectively allow a proxy to sign the transaction on their behalf. Device authentication of the user's pre-registered devices is also used as a means to validate the user's intent.

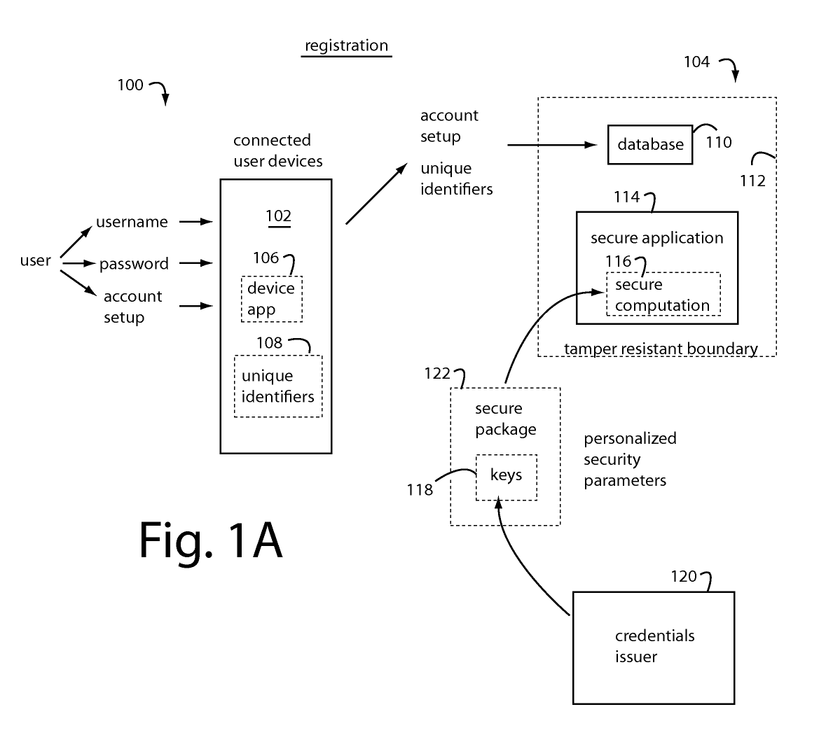

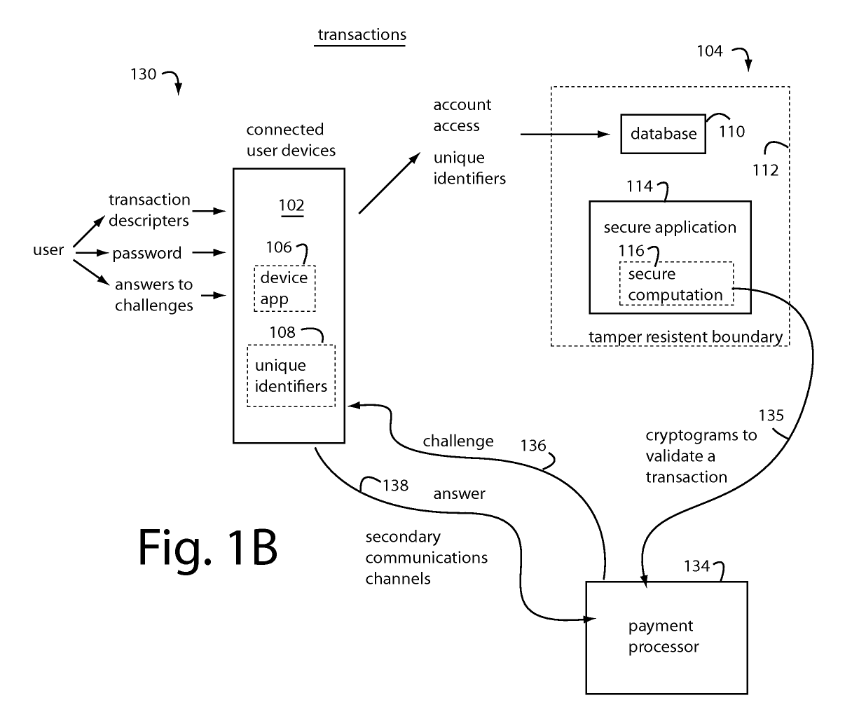

FIG. 1A represents a registration system 100 useful in one part of a virtual chipcard secure payment system embodiment of the present invention. The registration system 100 provides for fixing an inventory of connected user devices 102 that can thereafter be used as authorized devices in user transactions with a secure server 104. A device app 106 is installed or downloaded in one of more of the connected user devices 102 and provides a graphical user interface to control and guide a user through device registration and user transactions. Each connected user device 102 will naturally have unique identifiers 108 associated with it that can be used later in device authentication for a user transaction. These unique identifiers 106 are automatically explored, securely packaged, and forwarded by device app 106 to a database 110 is best disposed behind a tamper resistant boundary 112 in secure server 104.

A secure application 114 is included in a safe location in the Cloud to execute secure computations 116 using keys and algorithms 118 provided by a credentials issuer 120 inside a secure package 122. Such safe locations are often referred to as hardware security modules (HSM's) which are a type of secure cryptoprocessor for managing digital keys, accelerating digital signings, and for providing strong authentication in server applications. HSM's are usually built as plug-in cards or external TCP/IP security devices that can be attached directly to a server or general purpose computer. The cryptographic material handled by most HSM's are symmetric keys, and asymmetric key pairs and certificates used in public-key cryptography.

In a payment card system embodiment, each secure application 114 would be the equivalent of an EMV chipcard disposed in a cryptographic smartcard, and the keys and algorithms 118 represent the personalization data that would ordinarily coded into such an EMV chipcard. In one secure identity system embodiment, the secure application 114 would be the equivalent of a biometric template. A biometric sample would be collected by the connected user devices 102 and forwarded by the credentials issuer 120 to the secure server 104 for authentication by secure computation 116 using the biometric template in secure application 114. In another embodiment, users enter an appropriate identification protocol using one or several of their devices.

One important object in providing such registration in a financial payment card embodiment is to associate users' mobile wallets with corresponding mobile and other connected devices while assuring that the payment application key space is appropriately protected.

Each new user device 102 that is to be bound thereafter to a user requires a secure communication of the device credentials to an authentication part of a secure virtual chip card service in secure application 114. Here, static device credentials or dynamic device credentials could be used effectively. Transport Layer Security (TLS) and its predecessor, Secure Sockets Layer (SSL), are protocols that provide communication security over the Internet. TLS and SSL encrypt the segments of network connections above the Transport Layer, using asymmetric cryptography for key exchange, symmetric encryption for privacy, and cryptographic one-way functions for message integrity. Secure Remote Password (SRP) is a password-based authentication and key exchange protocol for secure authentication of clients to servers.

FIG. 1B represents a transaction system 130, useful in a virtual chipcard secure payment system, for securing user transactions with a form of virtual chip card maintained by a virtual chip card server operated in the “Cloud”. The virtual chip card server is commissioned to securely compute cryptographic operations on behalf of each user if, and only if, evidence is presented that the particular user is who they claim to be, and that such user actually intends to carry out the transaction at hand. The cryptograms are computed after being authorized and are then transparently forwarded from the secure server 104, e.g., to a payment processor 134 without circuiting through the user devices. The technology described by the present inventors in U.S. Pat. No. 8,078,879, issued Dec. 13, 2011, can be used to provide good results in many embodiments of the present invention. Such patent is incorporated in full by reference herein.

A transaction can be initiated by a user, a peer, or a merchant in a number of conventional ways. However initiated, a password that was previously associated with device app 106 is reentered by each user or a device function for comparison. The connected user devices 102 encode a message using such newly provided passwords, the unique identifiers 108, and other characterizing datapoints belonging to the device. Secure server 104 decodes these for user, device, and message authentications. If authenticated, cryptograms 135 are computed using the personalization data registered and held for that user, and the results are forwarded to the payment processor 134.

A challenge 136 may be sent to a second one of the connected user devices 102 using a different communications channel, such as SMS text, email, voice call, Internet, or even a POS terminal. In order for the proposed transaction to succeed, the users respond with their answers 138. These answers must satisfy and match acceptable answers stored or calculated in the database 110. Alternatively, a value may be computed on the device using inputs obtained by the device and/or user. The results are forwarded to payment processor 134, for comparison to values calculated from stored, registration inputs.

Here, public-key cryptography is used in a cryptographic system requiring two separate keys, one to lock or encrypt the plaintext, and one to unlock or decrypt the cyphertext. Neither key will do both functions. One of these keys is public and the other is kept private. Messages from the user devices are encrypted for signature verification in the Cloud, e.g., by the authentication servers. Cryptographic one-way functions can be used such as a calculation of a hash value of the message.

U.S. Pat. No. 7,725,723, issued May 25, 2010, to Peter Landrock, et al., describes signing electronic data with a digital signature for receipt by a signature server and an authentication server. Such patent is fully incorporated herein by reference and could be useful in implementing embodiments of the present invention. The signature server provides secure parking in the Cloud for the users' private cryptographic keys. Each user contacts the servers through a secure channel. A password or other token is furnished, based on information previously registered by the user. The authentication server forwards a derivative to the signature server for comparison with the one originally supplied by the user during registration. If there is a match, any message data received from the user is authenticated to be signed with the user's private key.

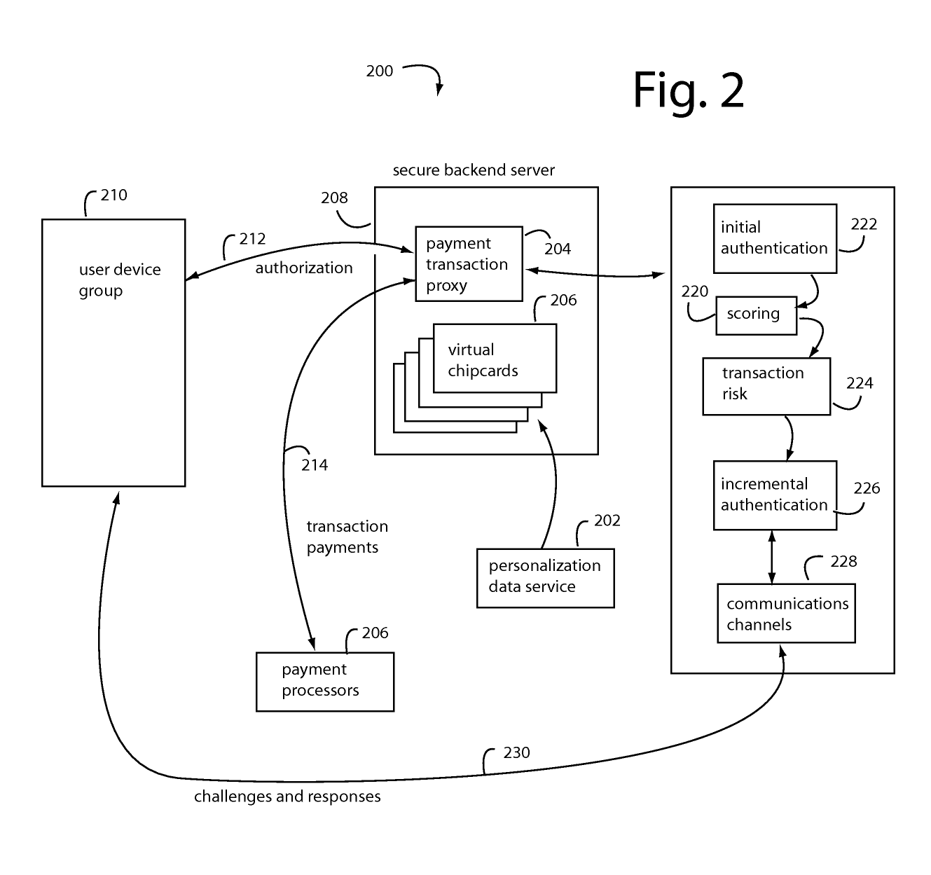

In FIG. 2, a virtual chipcard secure payment system 200 relies on a personalization data service mechanism 202 to provision a payment transaction proxy 204 with virtual EMV-type chipcards 206 on a secure backend server 208 all in the Internet Cloud. A user device group 210 with pre-registered devices in the hands of their respective users is equipped to authorize 212 the payment transaction proxy 204 to make transaction payments 214 for them. A payment processor 216 accepts payment transaction proxy 204 as it would a typical user engaged in an EMV-type smartcard transaction. The payment transaction proxy 204 is configured to carry out each job without exposing the cryptographic keys in its virtual chipcards 206 to risk.

The payment transaction proxy 204 includes a processor for erecting user, message, and/or device authentications in multifactor configurations in realtime to validate and confirm each user's intent to permit the payment transaction proxy to sign for a particular transaction on a user's behalf. The users' intent can be implied by their entering or acknowledging the transaction amount in a message as part of an identification protocol.

The payment transaction proxy 204 also includes a processor for leading users through a series of challenges or steps by the payment transaction proxy to validate the user's authenticity and intent. This can result in additional user devices and communications channels belonging to particular user device groups 210 being incrementally involved to strengthen an initial authentication. Each user is enabled to communicate with the payment transaction proxy 204 through a pre-registration process using their own unique collection of network-connectable computing devices.

The secure payment system 200 is equipped with a scoring device 220 for estimating the risk in an initial authentication 222 as can be determined from the first few authentication factors originally accepted by the payment transaction proxy 204. A transaction risk process 224 is used for identifying high risk transactions that require the highest confidence in the on-going authentication of the user, their involved devices, and the messages.

An additional authentication device 226 is used to incrementally link-in more user devices from device group 210, more communications channels 228, and to add user challenges and/or responses 230 to increase the number of security factors to be fulfilled in authenticating a particular high risk transaction. These additional measures will add more what-you-know and what-you-have type security factors. Some of these devices, channels, and messages may be able to add where-you-are and what-you-intend security factors for maximally strong, multi-factor authentication.

As described in connection with FIG. 1A, a pre-registration process 100 encodes and forwards unique identifiers 108 detectable in each of the network-connectable computing devices 102, and such unique identifiers are thereafter useable in device authentication 222 (FIG. 2) in support of a payment transaction 214. The pre-registration process 100 may additionally encode and forward user answers to stock challenges stored in database 110. The answers that users give during a later transaction are compared to the ones stored, and are thereby able to support user-authentication undertakings. Alternatively, the pre-registration process 100 may store security parameters that enable the secure package 122 to calculate values and compare them to values 230 forwarded using the same parameters available to the users and/or their devices. The initial authentication 222 or the incremental authentication 226 should include a process for having the user state or accept the amount of the transaction at hand.

The client-side software for execution on at least some of the mobile user devices 210 can be collectively implemented in-part with apps for mobile operating systems similar to Apple iOS and Google Android. The personalization data service 202 to provision the payment transaction proxy 204 with virtual EMV-type chipcards 206 on the secure backend server 208 includes a secure transmission 122 (FIG. 1A) of personalization data 118 from an issuing bank 120.

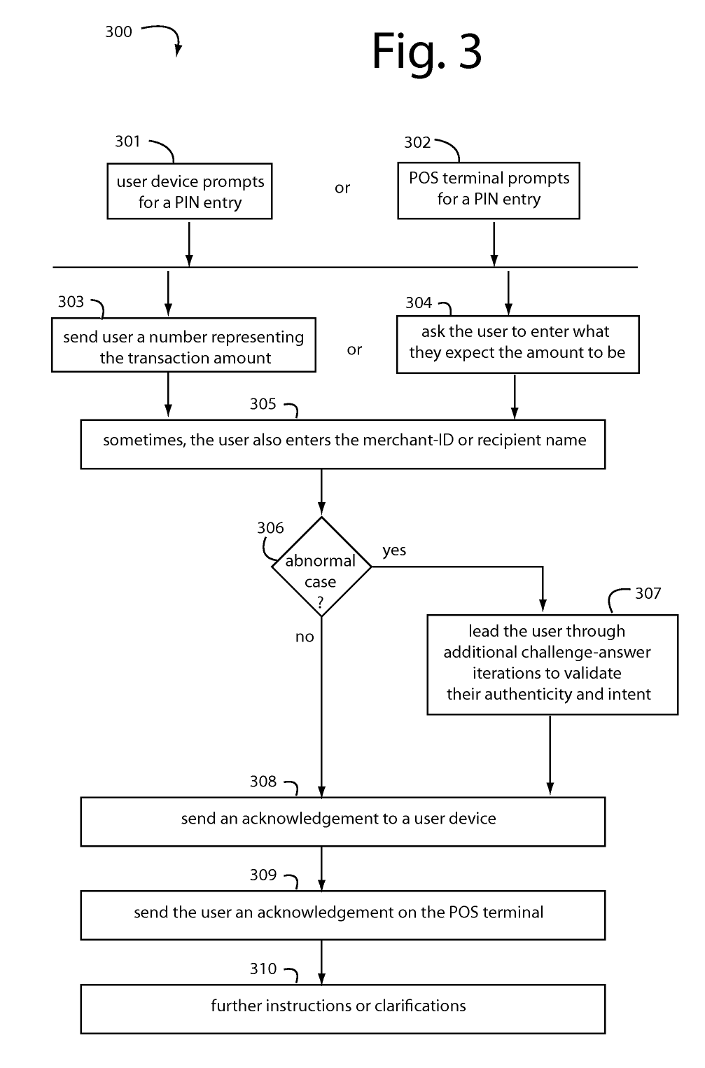

FIG. 3 represents a first scenario 300 in which a shopper uses their smart connected computing device, e.g., a phone, tablet, or PC, to make a purchase at a merchant's point of sale terminal (POS). Such smart connected computing device preferably has at least two independent channels of communication, such as the Web, email, SMS, voice, etc. These will help later in negotiating higher levels of authentication of the user, the device, and the purchase request message. In a step 301, the user device prompts the user for a PIN entry. Alternatively, in a step 302, the POS terminal instead prompts the user for a PIN entry. In response, the payment system sends the user device a number in step 303 indicating the money amount involved in the transaction. Or, in step 304 the user types in the amount to be approved. In some cases, the user also enters the merchant-ID or recipient name in a step 305. The user can therefore confirm or reject the proposed transaction.

In situations where the confidence in the authentication is marginal for some reason, or the amounts of the transaction are unusually high, or the place of the transaction is odd, or the kind of transaction is out of character, or other abnormal cases, a decision 306 is made to lead the user in a step 307 through additional challenge-answer iterations to validate their authenticity and intent. These additional authentication steps are preferably conducted by separate channel, such as by phone call, SMS text, email, website, and/or by way of another device also registered to this user. In a step 308, the user receives an electronic acknowledgement through an appropriate channel on one of their devices. Or, in a step 309, the user receives an electronic acknowledgement on the POS terminal. Occasionally, a step 310 electronically sends further instructions for the user to do something more or to clarify an ambiguity.

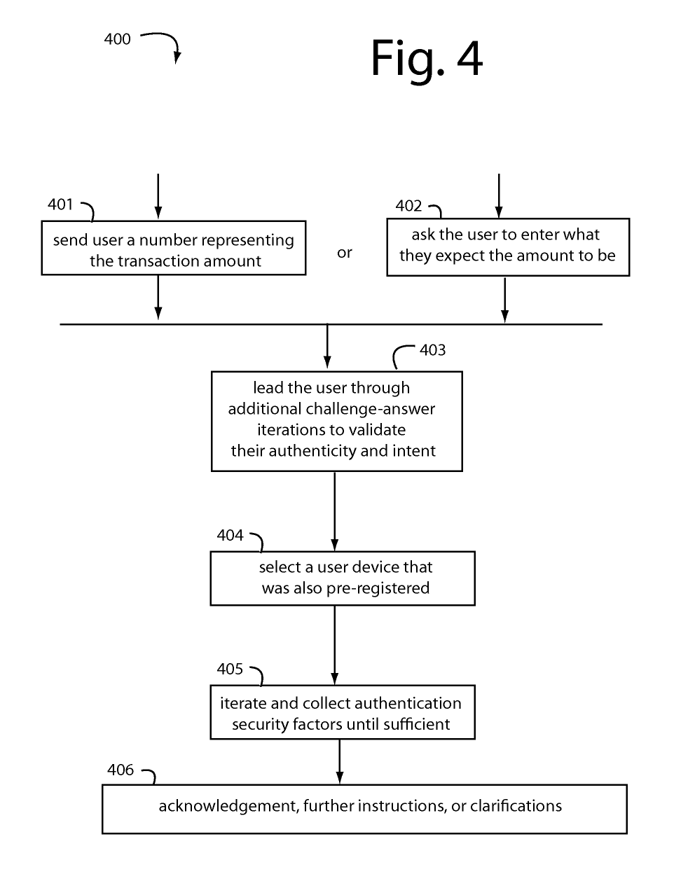

FIG. 4 represents a second scenario 400 in which a shopper uses more than one of their smart connected computing devices, e.g., a phone, tablet, or PC, to make a purchase remote from a merchant's point of sale terminal (POS) or to engage in a transaction with a peer. For example, an on-line purchase sometimes called a card-not-present transaction. In a step 401, the user receives the amount of the proposed transaction on their device, or in a step 402 the user types in the amount of the proposed transaction. In a step 403, the user is led through a number of challenge-answer or forwarding iterations to validate their authenticity and intent. These are conducted in a step 404 through parallel channels, e.g., a phone call, SMS text, email, or by connecting through another registered device available at the moment to the user. The user is therefore prompted to supply data for further authentication of the user, the device, and the transaction request message, in a step 405. The user receives an acknowledgement, optionally with further instructions, in a step 406.

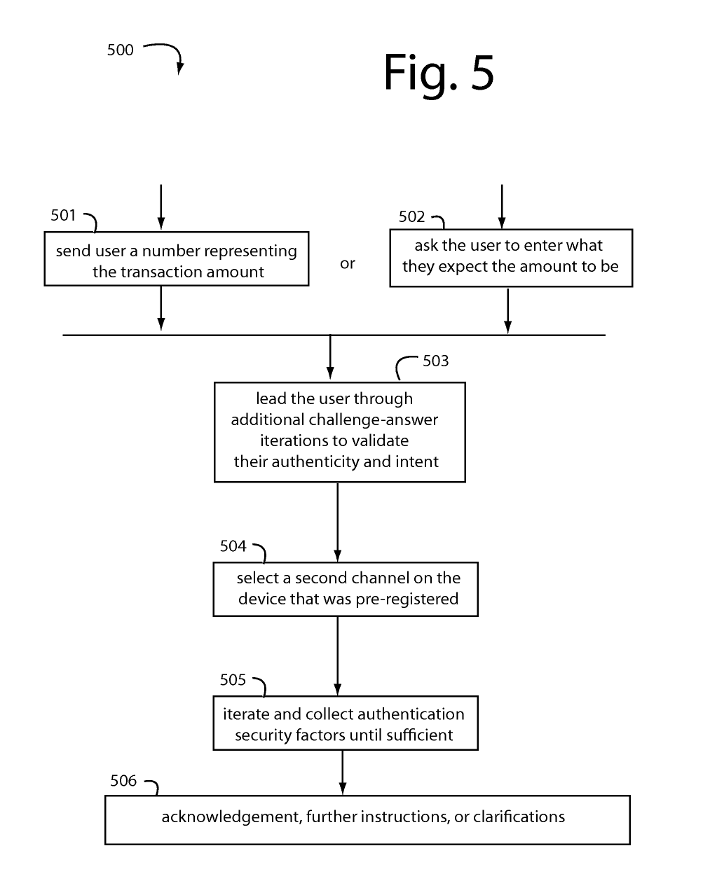

FIG. 5 represents a third scenario 500 in which a shopper has only one of their smart connected computing devices on hand, e.g., a phone, tablet, or PC, and uses it to make a purchase remote from a merchant's point of sale terminal (POS) or to engage in a transaction with a peer. E.g., in a card-not-present transaction. In a step 501, the user receives the amount of the proposed transaction on their device, or in a step 502 the user types in the amount of the proposed transaction. In a step 503, the user is led through a number of challenge-answer or forward iterations to validate their authenticity and intent. These are conducted in a step 504 through parallel channels, e.g., a phone call, SMS text, email, but on a single user device like a smartphone. The user is prompted for further authentication of the user, the device, and the transaction request message, in a step 505. The user receives an acknowledgement, optionally with further instructions, in a step 506.

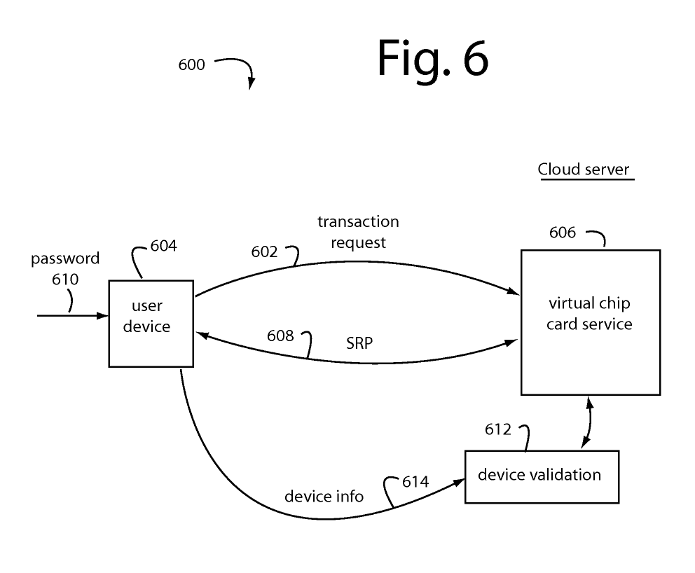

FIG. 6 represents how requests for transactions 602 are forwarded by user devices 604 to a virtual chip card service 606, such as can be implemented with secure server 104 (FIGS. 1A-1B). The transaction requests 602 are authenticable in many different ways. Each transmitted request and resulting session is protected using secure remote password (SRP) protocol 608. SRP is a secure password-based authentication and key-exchange protocol. It is used here to securely authenticate clients 604 to servers 606. The users of the client software must memorize a small secret, e.g., a password 610. The server verifies each user to authenticate the client. An attacker cannot impersonate the client because SRP exchanges a cryptographically-strong secret following a successful authentication. The mutual exchange enables the parties to securely communicate between themselves and to the exclusion of third parties. User devices are validated 612 using (a) static device-specific information 614 such as device ID, IMEI, subscriber name, subscriber number, device specific serial numbers, etc.; or, (b) a secure signing service such as a trusted platform module (TPM) on the device for an appropriate authentication of the device protocol, such as in challenge-response, forwarding, Open Mobile Alliance-Digital Right Management (OMA-DRM) dedicated on-board chip, or on a programmable on-board chip.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. (canceled)

2. A virtual payment chipcard service method for reducing payment card fraud, comprising:
steps for maintaining chipcard authorization data and computational services as virtual assets in the Cloud and behind tamper resistant boundaries;
steps for electronically signing a transaction as a proxy to a virtual chip-card payment;
steps for receiving user transaction requests on one user communication channel, and for responding with corresponding confirmations different user communication channel.

3. The virtual payment chipcard service method of claim 2, further comprising:
steps for responding to said user transaction requests and for identifying a corresponding user, any user devices involved in the steps for receiving user transaction requests, and a transaction amount.

4. The virtual payment chipcard service method of claim 3, further comprising:
steps for authenticating said user devices according to information both derived from pre-registered personalized security parameters and on an input currently provided.

5. The virtual payment chipcard service method of claim 2, further comprising:
steps for emulating a chip-card calculation able to produce a signing credential associated with a particular user.

6. The virtual payment chipcard service method of claim 2, further comprising:
steps for validating a user's intent after authentication of the user and/or the message.

7. The virtual payment chipcard service method of claim 2, further comprising:
steps for selecting and cryptographically producing a transaction authorization of a particular payment method analogous to chip authentication protocol (CAP) or VISA dynamic passcode authentication (DPA), wherein no protocol replacement is required for a selected payment method; and
steps for forwarding transaction details that suit a particular payment method after receiving back an authorization by said different user communication channel.

8. The virtual payment chipcard service method of claim 2, further comprising:
steps for identifying and associating user devices, and for preventing man-in-the-middle attacks that attempt to alter transaction data.

9. The virtual payment chipcard service method of claim 2, further comprising:
steps for establishing an initial protocol for any device involved in a transaction be to reply with correct answers to questions that are initially only shared between the device and a backend authentication server.

10. The virtual payment chipcard service method of claim 2, further comprising:
steps for authorizing a transaction by include a step for reciting some substantial details of a particular transaction.

11. The virtual payment chipcard service method of claim 2, wherein, chipcard type payments are further secured in the Cloud by keeping cryptographic keys concealed.
